(19) United States
(12) Patent Application Publication
(10) Pub. No.: US 2012/0268385 A1
(43) Pub. Date: Oct. 25, 2012

(54) UV-ILLUMINATED SYMBOLS FOR A USER DEVICE

(75) Inventors: Linus Frantzich, Lund (SE); Alexander Hunt, Tygelsjo (SE)

(73) Assignee: SONY ERICSSON MOBILE COMMUNICATIONS AB, Lund (SE)

(21) Appl. No.: 13/391,411

(22) PCT Filed: Mar. 9, 2011
(86) PCT No.: PCT/IB11/50986

§ 371 Date: Feb. 21, 2012

(51) Int. Cl. H01H 13/83; G06F 3/02

(52) U.S. Cl. 345/170; 200/5 A

(57) ABSTRACT

A user device comprising a keypad or a keyboard comprising one or more buttons; one or more light guides; one or more ultraviolet light emitting elements; and at least one of one or more fluorescently painted symbols or one or more fluorescent three-dimensional symbols, wherein the one or more ultraviolet light emitting elements are configured to expose ultraviolet light to the at least one of the one or more fluorescently painted symbols or the one or more fluorescent three-dimensional symbols via the one or more light guides.

### BACKGROUND

User devices, such as mobile and handheld devices, include keypads. Often times, the keypads have some form of illumination to allow users to see various symbols, such as, numbers, letters, etc., clearly. Unfortunately, difficulties exist for getting these various symbols to illuminate evenly in a uniform fashion. For example, according to some architectures, keydomes are placed under the symbols, and for other architectures, it is difficult to obtain an even distribution of light in a light guide. Additionally, according to some architectures, leakage of visible light often occurs when illuminating symbols.

### SUMMARY

According to one aspect, a user device may comprise a keypad or a keyboard comprising one or more buttons; one or more light guides; and one or more ultraviolet light emitting elements. The user device may also comprise one or more fluorescently painted symbols, wherein each fluorescently painted symbol comprises a fluorescent paint that is visible to a user when exposed to visible light and is capable of emitting visible light when exposed to ultraviolet light, wherein the one or more ultraviolet light emitting elements are configured to expose ultraviolet light to the one or more fluorescently painted symbols via the one or more light guides.

Additionally, the user device may comprise one or more light sensors to detect a level of light external to the user device, wherein the one or more ultraviolet light emitting elements may be configured to emit ultraviolet light based on the level of light detected by the one or more light sensors.

Additionally, at least one of the one or more fluorescently painted symbols may be in the shape of a number, a letter, a mark, or a sign.

Additionally, at least one of the one or more light guides may comprise at least one of the one or more fluorescently painted symbol.

Additionally, at least one of the one or more buttons may comprise at least one of the one or more fluorescently painted symbols.

Additionally, at least one of a surface of the one or more light guides may comprise at least one of the one or more fluorescently painted symbols

Additionally, at least one of the one or more ultraviolet light emitting elements may be on a same plane as at least one of the one or more light guides and may be at a lateral location to at least one of the one or more fluorescently painted symbols.

Additionally, the user device may further comprise a display and a layer covering the display, wherein at least one of the one or more fluorescently painted symbols resides on a bottom surface of the layer or within the layer.

Additionally, the one or more buttons may comprise at least one of a push button or a touch button.

Additionally, the one or more light guides may comprise a material that is ultraviolet light-transparent, and the user device may comprise a mobile communication device.

According to another aspect, a user device may comprise a keypad or a keyboard comprising one or more buttons; one or more light guides; and one or more ultraviolet light emitting elements. The user device may further comprise one or more fluorescent three-dimensional symbols, wherein each fluorescent three-dimensional symbol may be capable of emitting visible light when exposed to ultraviolet light, and wherein the one or more ultraviolet light emitting elements are configured to expose ultraviolet light to the one or more fluorescent three-dimensional symbols via the one or more light guides.

Additionally, the user device may further comprise one or more light sensors to detect a level of light external to the user device, wherein the one or more ultraviolet light emitting elements may be configured to emit ultraviolet light based on the level of light detected by the one or more light sensors.

Additionally, the one or more fluorescent three-dimensional symbol may comprise an ultraviolet light-transparent material further comprising a three-dimensional section having a shape of a three-dimensional symbol, in which the three-dimensional section may comprise the ultraviolet light-transparent material and fluorescent pigments or particles. Additionally, at least one of the one or more fluorescent three-dimensional symbols may be in the shape of a number, a letter, a mark, or a sign.

Additionally, at least one of the one or more light guides may comprise at least one of the one or more fluorescent three-dimensional symbols.

Additionally, at least one of the one or more buttons may comprise at least one of the one or more fluorescent three-dimensional symbols.

Additionally, the one or more buttons may be touch buttons.

Additionally, the one or more light guides may comprise a material that is ultraviolet light-transparent.

Additionally, the user device may comprise a display; and a layer covering the display, wherein at least one of the one or more fluorescent three-dimensional symbols may resides on a bottom surface of the layer or within the layer.

Additionally, the user device may comprise a mobile communication device.

### BRIEF DESCRIPTION OF THE DRAWINGS

The accompanying drawings, which are incorporated in and constitute a part of this specification, illustrate exemplary embodiments described herein and, together with the description, explain these exemplary embodiments. In the drawings:

FIG. 1A is a diagram illustrating a cross-sectional view of an exemplary embodiment of a user device comprising a fluorescently painted symbol;

FIG. 1B is a diagram illustrating a cross-sectional view of another exemplary embodiment of a user device comprising a fluorescently painted symbol;

FIG. 1C is a diagram illustrating a cross-sectional view of another exemplary embodiment of a user device comprising a fluorescently painted symbol;

FIG. 1D is a diagram illustrating an exemplary fluorescent three-dimensional symbol;

FIG. 1E is a diagram illustrating a cross-sectional view of an exemplary embodiment of a user device comprising a fluorescent three-dimensional symbol;

FIG. 1F is a diagram illustrating a cross-sectional view of another exemplary embodiment of a user device comprising a fluorescent three-dimensional symbol;

FIG. 1G is a diagram illustrating a cross-sectional view of another exemplary embodiment of a user device comprising a fluorescent three-dimensional symbol;

FIG. 2 is a diagram illustrating an exemplary user device in which exemplary embodiments described herein may be implemented; and

FIG. 3 is a diagram illustrating exemplary components of the user device depicted in FIG. 2.

### DETAILED DESCRIPTION

The following detailed description refers to the accompanying drawings. The same reference numbers in different drawings may identify the same or similar elements. Also, the following description does not limit the invention. Rather, the scope of the invention is defined by the appended claims.

The term “symbol,” as used herein, is intended to be broadly interpreted to include, for example, a number, a letter, a logo, a notation, a mark, a sign, an icon, a figure, or other expression or representation. By way of example, a user device, such as a mobile device, a handheld device, a tablet device, or a portable device may include various letters, words, numbers, signs (e.g., $, &, *, @, etc.), marks (e.g., punctuation marks, etc.), icons (e.g., an icon of an envelope, an icon of a person, an icon to represent a function or a service, etc.), as well as other types of graphical and/or printed representations. The user device may include symbols with, for example, a keypad or a keyboard. Additionally, or alternatively, the user device may include symbol(s) with respect to another part of the user device, such as, for example, a housing portion of the user device, a display portion of the user device, a perimeter of the display portion, or other suitable location. By way of further example, a symbol may be used to identify an input port (e.g., headset symbol), an output port, a company logo, etc. According to exemplary embodiments, a symbol may take the form of a fluorescent three-dimensional (3-D) symbol and a fluorescently-painted symbol, which may be illuminated by ultraviolet (UV) light (i.e., ultraviolet radiation of the electromagnetic spectrum), as described further below.

According to an exemplary embodiment, a user device may include a fluorescent three-dimensional symbol(s). The fluorescent three-dimensional symbol may comprise a material, which is transparent to ultraviolet light, and further comprises (homogeneously-distributed) fluorescent pigments (e.g., fluorescent particles). According to an exemplary embodiment, the fluorescent pigments may occupy space within the UV-transparent material to form the shape of a fluorescent three-dimensional symbol.

According to an exemplary embodiment, the fluorescent three-dimensional symbol may be situated in various locations of the user device, such as, for example, within a button, within a light guide, proximate to a light guide, proximate to a button, or other suitable locations (e.g., proximate to or within a housing, proximate to or within a display, a front side of the user device, a back side of the user device, an inner side of the user device, a left side, a right side, a top side, a bottom side, etc.).

According to an exemplary embodiment, the fluorescent three-dimensional symbol may be illuminated using ultraviolet light (e.g., by an ultraviolet light emitting diode (UV LED(s))), which may cause the fluorescent pigments to become visible to a user when in low-light or dark environments. Additionally, according to an exemplary embodiment, the fluorescent pigments may have a particular color (e.g., a whitish color or other suitable color) when not illuminated by ultraviolet light, so that the fluorescent three-dimensional symbol may be visible to a user when in lighted environments (e.g., outdoors, indoors, etc.) and exposed to visible light. When illuminated, the three-dimensional symbol may provide a visual effect of the symbol floating within a button, key, or other input mechanism.

According to another exemplary embodiment, a user device may include a fluorescently-painted symbol(s). The fluorescent paint may be used to form the shape of a symbol. According to an exemplary embodiment, the fluorescently-painted symbol may be situated in various locations of the user device, such as, for example, within a button, within a light guide, proximate to a light guide, proximate to a button, or other suitable locations (e.g., proximate to or within a housing, proximate to or within a display, a front side of the user device, a back side of the user device, an inner side of the user device, a left side, a right side, a top side, a bottom side, etc.)

According to exemplary embodiment, the fluorescently-painted symbol may be illuminated using ultraviolet light (e.g., by UV LED(s)), which may cause the fluorescently-painted symbol to become visible to a user when in low-light or dark environments. Additionally, according to an exemplary embodiment, the fluorescently-painted symbol may react to visible light, such as, indoor light, sunlight, etc., to permit the user to see the fluorescently-painted symbol when in lighted environments.

As a result of the foregoing, light leakage may be significantly reduced. Additionally, the scattering of light caused by imperfections in the composition of, for example, a light guide, a button, etc., may be significantly reduced. Additionally, imperfections in the composition of various materials of components pertaining to the display of symbols may not be as visible to the human eye, as well as other advantages that naturally flow therefrom.

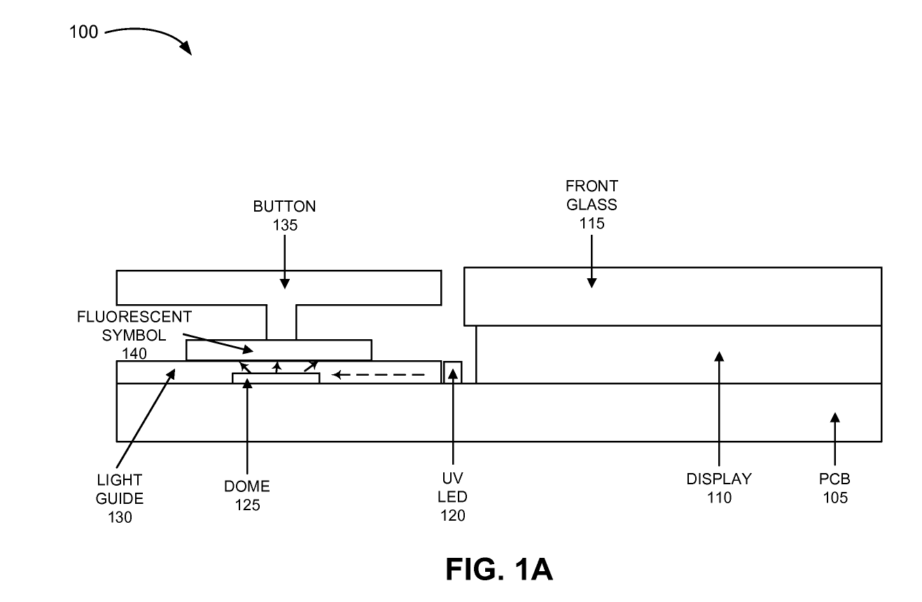

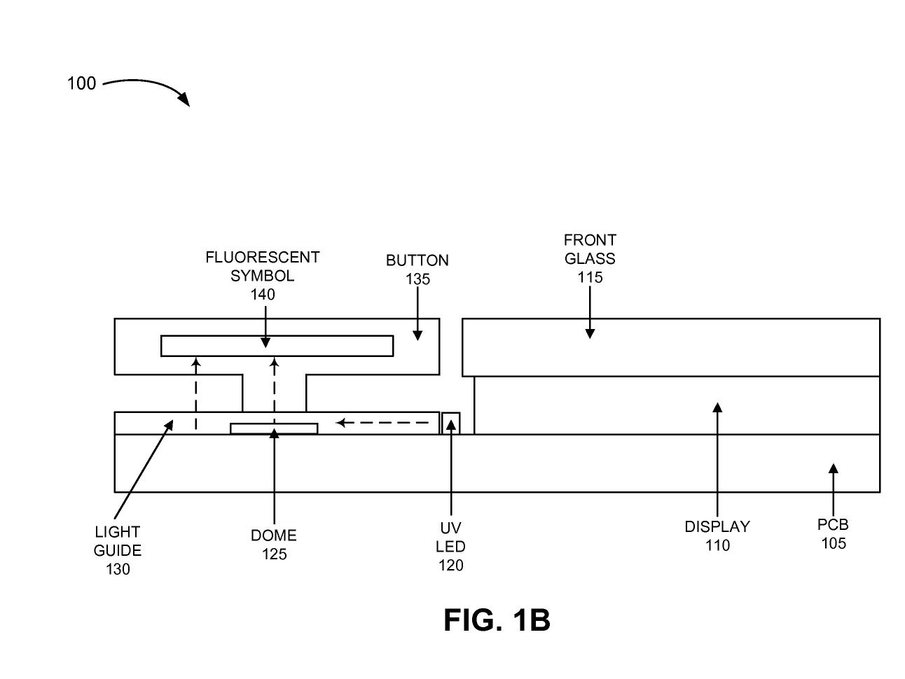

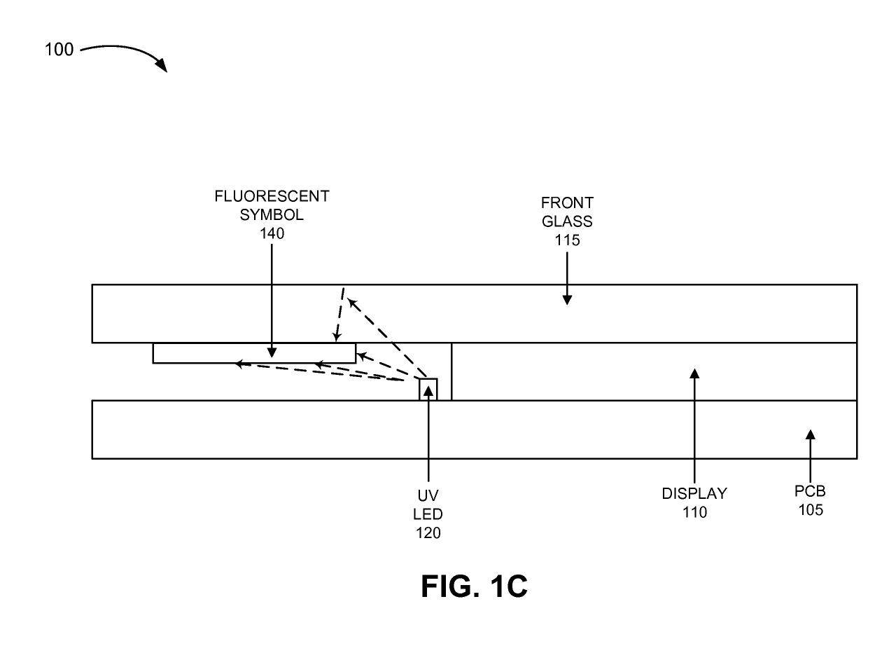

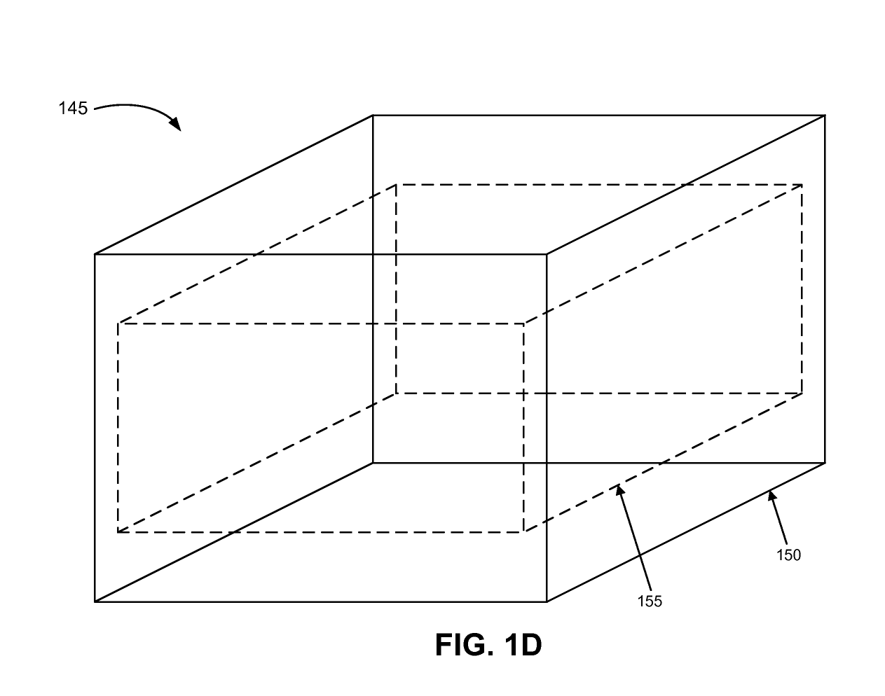

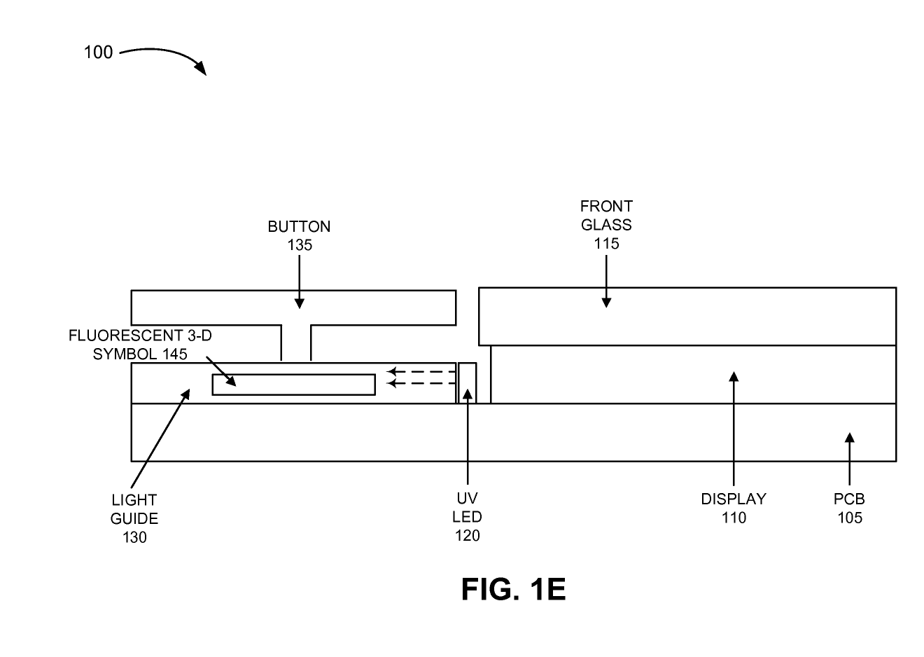

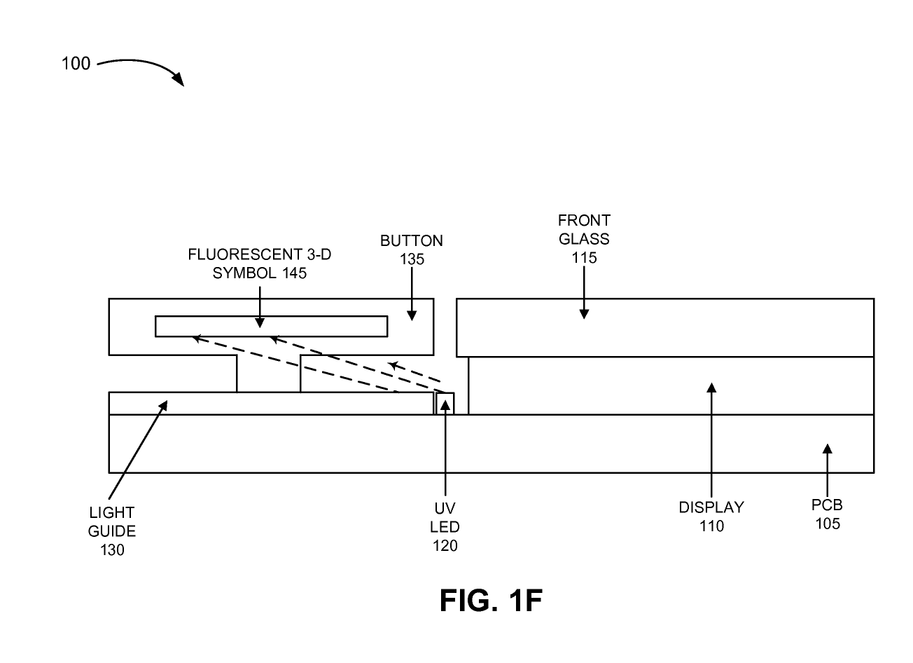

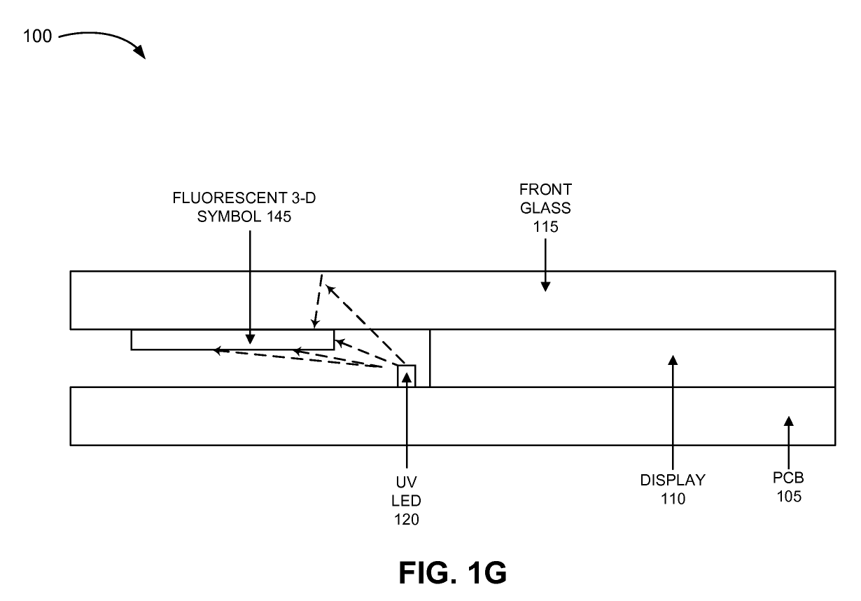

FIGS. 1A-1C are diagrams illustrating exemplary embodiments of a user device comprising a fluorescently-painted symbol. FIG. 1A is a diagram illustrating a cross-sectional view of an exemplary embodiment of a user device 100 comprising a fluorescently painted symbol. As illustrated, user device 100 may comprise a printed circuit board (PCB) 105, a display 110, a UV light emitting diode (LED) 120, a dome 125, a light guide 130, a button 135, and a fluorescent symbol 140.

PCB 105 may comprise hardware components (e.g., processing system, memory, etc.) and software components to provide various functions pertaining to user device 100. Display 110 may comprise a liquid crystal display (LCD), a plasma display panel (PDP), a field emission display (FED) a thin film transistor (TFT) display, or some other type of display technology. Front glass 115 may comprise a piece of glass or other type of (protective) covering, layer, or film (e.g., plastic, etc.) for display 110.

UV LED 120 may comprise a UV LED or other suitable element capable of emitting ultraviolet light. The spectrum of ultraviolet light can range from approximately 400 nanometers (nm) to approximately 10 nanometers (nm), which is sometimes divided into longwave, middlewave, shortwave, and extreme. According to an exemplary embodiment, UV LED 120 may emit longwave ultraviolet light (e.g., 315 nm-415 nm). However, depending on the composition of light guide 130, the reactive nature of the fluorescent paint to ultraviolet light, the composition of front glass 115, etc., the spectrum or sub-spectrum of the ultraviolet light emitted by UV LED 120 may be selected to yield the optimal visual effect. According to this example, UV LED 120 may reside on a same plane as light guide 130. Additionally, UV LED 120 may reside at a lateral location to or an adjacent location to fluorescent symbol 140.

Dome 125 may include an element that provides contact to PCB 105 when button 135 is in a depressed position. Although not illustrated, according to an exemplary implementation, when button 135 is a push-button, PCB 105 may include a dome switch target, which is activated, when button 135 is in the depressed position.

Light guide 130 may include an element that directs and/or allows light to propagate. Light guide 130 may be made from optical-grade material that is transparent to ultraviolet light (i.e., the full spectrum of ultraviolet light or at least a portion of the ultraviolet light spectrum). For example, light guide 130 may be made from glass (e.g., silica, quartz glass), acrylic plastic, or other suitable material. Alternatively, light guide 130 may correspond to an air space, an air passageway, or other suitable configuration for a light guide.

Button 135 may comprise a button (e.g., a push-button, a touch button). According to an exemplary implementation, button 135 may be a part of a keypad or a keyboard. According to other implementations, button 135 may correspond to a navigational pad or other input mechanism. According to embodiments in which button 135 is a touch button, button 135 may include a capacitance-based touch sensitive button, a resistance-based touch sensitive button, or some other type of touch sensitive button.

Fluorescent symbol 140 may comprise a fluorescently-painted symbol. As illustrated in FIG. 1A, the fluorescently-painted symbol may be painted on a surface (e.g., a top surface) of light guide 130. Alternatively, fluorescent symbol 140 may be within light guide 130 (not illustrated). According to an exemplary implementation, fluorescent symbol 140 may comprise a visible fluorescent paint, which is visible under white light (e.g., sunlight, indoor lighting, etc.), and may glow when exposed to ultraviolet light. As further illustrated in FIG. 1A, according to an exemplary implementation, UV LED 120 may reside at a lateral location to fluorescent symbol 140 and may emit ultraviolet light into light guide 130, as illustrated by the (dotted) arrows, to illuminate fluorescent symbol 140. According to such an implementation, UV LED 120 may be a side-lit LED. Additionally, according to an exemplary implementation, although not illustrated, UV LED 120 may be activated or triggered to emit ultraviolet light based on a light sensor. The light sensor may detect the amount of light in the environment in which user device 100 is located. For example, UV LED 120 may emit ultraviolet light when user device 100 is in low-light or dark environments based on a signal from the light sensor.

FIG. 1B is a diagram illustrating a cross-sectional view of another exemplary embodiment of user device 100 comprising fluorescent symbol 140. According to this exemplary embodiment, button 135 may comprise fluorescent symbol 140. That is, fluorescent symbol 140 may reside within button 135. As illustrated in FIG. 1B, according to an exemplary implementation, UV LED 120 may reside at a lateral location to fluorescent symbol 140 and may emit ultraviolet light into light guide 130, as illustrated by the (dotted) arrows, to illuminate fluorescent symbol 140. According to such an implementation, UV LED 120 may be a side-lit LED. According to this embodiment, button 135 may comprise a material that is UV light-transparent to allow the ultraviolet light to react with the fluorescent paint of fluorescent symbol 140 and become visible to the user. According to an exemplary implementation, UV LED 120 may reside at a lateral location to and on a different plane from fluorescent symbol 140. Similar to that previously described, a light sensor (not illustrated) may be used to activate or trigger the emission of ultraviolet light by UV LED 120 based on lighting conditions.

FIG. 1C is a diagram illustrating a cross-sectional view of another exemplary embodiment of user device 100 comprising fluorescent symbol 140. According to this exemplary embodiment, fluorescent symbol 140 may be affixed (e.g., painted on) to front glass 115. For example, fluorescent symbol 140 may be affixed to a bottom surface of front glass 115. According to another implementation, front glass 115 may comprise fluorescent symbol 140. That is, fluorescent symbol 140 may reside within front glass 115. As illustrated in FIG. 1C, according to an exemplary implementation, UV LED 120 may reside at a lateral location to and on a different plane from fluorescent symbol 140 and may emit ultraviolet light toward fluorescent symbol 140 and/or front glass 115, as illustrated by the (dotted) arrows. According to an exemplary implementation, UV LED 120 may be a top-lit LED. Front glass 115 may be composed of a material that is UV light-transparent. Similar to that previously described, a light sensor (not illustrated) may be used to activate or trigger the emission of ultraviolet light by UV LED 120 based on lighting conditions.

FIG. 1D is a diagram illustrating an exemplary fluorescent three-dimensional symbol 145. As illustrated, fluorescent three-dimensional symbol 145 may include an outer shell 150 and an inner shell 155. Outer shell 150 may comprise a UV-transparent material (e.g., silica, quartz glass), acrylic plastic, or other suitable material) and inner shell 155 may comprise a UV-transparent material with fluorescent pigments Inner shell 155 may be of a shape corresponding to a three-dimensional symbol. In this regard, the shapes of outer shell 150 and/or inner shell 155 may be different than those illustrated in FIG. 1D and are illustrated as boxes for ease of description.

FIGS. 1E-1G are diagrams illustrating exemplary embodiments of user device 100 comprising a fluorescent three-dimensional symbol 145. According to exemplary embodiments, button 135 may correspond to a touch button.

FIG. 1E is a diagram illustrating a cross-sectional view of an exemplary embodiment of user device 100 comprising fluorescent three-dimensional symbol 145. According to this exemplary embodiment, fluorescent three-dimensional symbol 145 may reside within light guide 130. Alternatively, fluorescent three-dimensional symbol 145 may reside on a surface (e.g., top surface) of light guide 130 (not illustrated). As further illustrated in FIG. 1E, according to an exemplary implementation, UV LED 120 may reside at a lateral location to and on a different plane from fluorescent three-dimensional symbol 145 and may emit ultraviolet light into light guide 130, as illustrated by the (dotted) arrows, to illuminate fluorescent three-dimensional symbol 145. According to such an implementation, UV LED 120 may be a side-lit LED. Similar to that previously described, a light sensor (not illustrated) may be used to activate or trigger the emission of ultraviolet light by UV LED 120 based on lighting conditions.

FIG. 1F is a diagram illustrating a cross-sectional view of another exemplary embodiment of user device 100 comprising fluorescent three-dimensional symbol 145. According to this exemplary embodiment, button 135 may comprise fluorescent three-dimensional symbol 145. That is, fluorescent three-dimensional symbol 145 may reside within button 135. As illustrated in FIG. 1F, according to an exemplary implementation, UV LED 120 may reside at a lateral location to fluorescent three-dimensional symbol 145 and may emit ultraviolet light into light guide 130, as illustrated by the (dotted) arrows, to illuminate fluorescent three-dimensional symbol 145. According to this embodiment, button 135 may comprise a material that is UV light-transparent to allow the ultraviolet light to react with the fluorescent pigments of fluorescent three-dimensional symbol 145 and become visible to the user. Similar to that previously described, a light sensor (not illustrated) may be used to activate or trigger the emission of ultraviolet light by UV LED 120 based on lighting conditions. According to such an embodiment, button 135 and or fluorescent three-dimensional symbol 145 may comprise a film (e.g., a conductive film, a capacitive film, etc.), a layer or space to permit the propagation of an electrical signal, and/or other touch-sensitive component (not illustrated) to permit button 135 to operate as a touch button.

FIG. 1G is a diagram illustrating a cross-sectional view of another exemplary embodiment of user device 100 comprising fluorescent three-dimensional symbol 145. According to this exemplary embodiment, fluorescent three-dimensional symbol 145 may be affixed to front glass 115. For example, fluorescent three-dimensional symbol 145 may be affixed to a bottom surface of front glass 115. According to another implementation, front glass 115 may comprise fluorescent three-dimensional symbol 145. That is, fluorescent three-dimensional symbol 145 may reside within front glass 115. As illustrated in FIG. 1G, according to an exemplary implementation, UV LED 120 may reside at a lateral location to and on a different plane from fluorescent symbol 145 and may emit ultraviolet light toward fluorescent three-dimensional symbol 145 and/or front glass 115, as illustrated by the (dotted) arrows. According to such an implementation, UV LED 120 may be a top-lit LED. Front glass 115 may be composed of a material that is UV light-transparent. Similar to that previously described, a light sensor (not illustrated) may be used to activate the emission of ultraviolet light by UV LED 120 based on lighting conditions.

According to the embodiments described, eye safety regulations must be considered since ultraviolet light can be harmful to the human eye. However, if properly designed, the amount of ultraviolet light emitted outside of user device 100 may be minimal, if any. For example, UV LED(s) 120 used may be of low power, certain components may not be UV-transparent, orientation of UV LED(s) 120 may be positioned to minimize ultraviolet light leakage, etc. Additionally, according to other embodiments, UV LED 120 may be positioned in locations other than those illustrated in FIGS. 1A-1C and 1E-1G. Still further, according to other embodiments, the number of UV LEDs 120 may be greater than a single UV LED 120, as illustrated in FIGS. 1A-1C and 1E-1G, and/or the number of light guides 130, and/or other elements illustrated, may be greater than that illustrated..

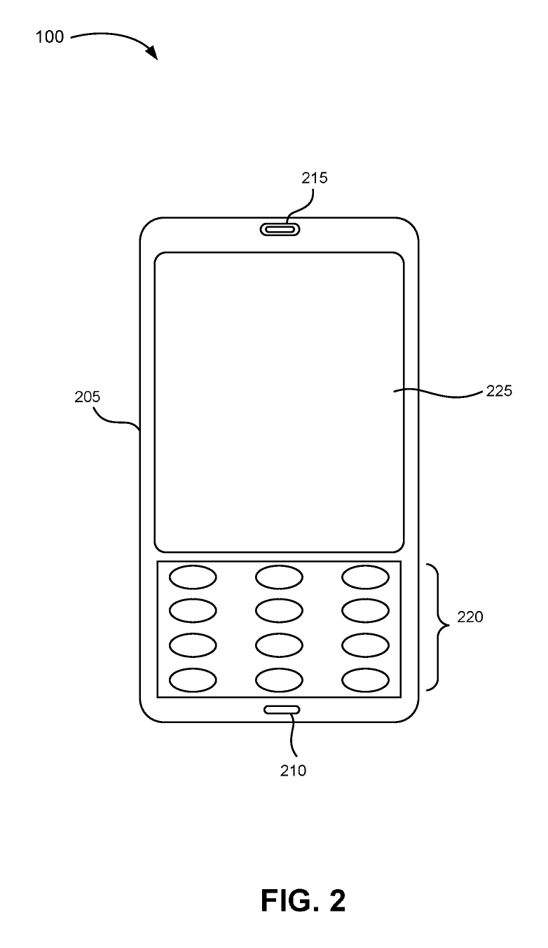

FIG. 2 is a diagram illustrating an exemplary user device 100 in which exemplary embodiments described herein may be implemented. The term “user device,” as used herein, is intended to be broadly interpreted to comprise a variety of devices. User device 100 may correspond to a portable device, a mobile device, a tablet device, a stationary device, or a handheld device. For example, user device 100 may take the form of a telephone (e.g., a smart phone, a radio phone, a cellular phone, a wireless phone, etc.), a personal digital assistant (PDA), a data organizer, a calculator, a picture capturing device, a video capturing device, a computer, a Web-access device, a music playing device, a location-aware device, a gaming device, a computer, and/or some other type of user device.

As illustrated in FIG. 2, user device 100 may comprise a housing 205, a microphone 210, speakers 215, keys 220, and a display 225. According to other embodiments, user device 100 may comprise fewer components, additional components, different components, and/or a different arrangement of components than those illustrated in FIG. 2 and described herein. Additionally, or alternatively, although user device 100 is depicted as having a portrait configuration, according to other embodiments, user device 100 may have a landscape configuration or some other type of configuration (e.g., a clamshell configuration, a slider configuration, a candy bar configuration, a swivel configuration, etc.).

Housing 205 may comprise a structure to contain components of user device 100. For example, housing 205 may be formed from plastic, metal, or some other type of material. Housing 205 may structurally support microphone 210, speakers 215, keys 220, and display 225. Microphone 210 may transduce a sound wave to a corresponding electrical signal. For example, a user may speak into microphone 210 during a telephone call, to execute a voice command, to execute a voice-to-text conversion, etc. Speakers 215 may transduce an electrical signal to a corresponding sound wave. For example, a user may listen to music, to a calling party, etc., through speakers 215.

Keys 220 may provide input to user device 100. For example, keys 220 may comprise a standard telephone keypad, a QWERTY keypad, and/or some other type of keypad (e.g., a calculator keypad, a numerical keypad, etc.). Keys 220 may also comprise special purpose keys to provide a particular function (e.g., send a message, place a call, open an application, etc.) and/or allow a user to select and/or navigate through user interfaces or other content displayed by display 225. According to an exemplary embodiment, one or more keys 220 may comprise fluorescently-painted symbol(s) and/or three-dimensional fluorescent symbol(s). For example, one or more keys 220 may be illuminated using fluorescently-painted symbols and/or three-dimensional symbols, as described herein.

As previously described, although not illustrated, user device 100 may be one of many different types of configurations, such as, for example, a landscape configuration a clamshell configuration, a slider configuration, a candy bar configuration, a swivel configuration, a tablet configuration, etc. However, for each of these configurations and for others specifically not mentioned, one or more keys 220, a keypad, a keyboard, an input component, etc., may comprise fluorescently-painted symbol(s) and/or three-dimensional symbol(s).

Additionally, or alternatively, fluorescently-painted symbol(s) and/or three-dimensional fluorescent symbol(s) may be located elsewhere with respect to user device 100. For example, fluorescently-painted symbol(s) and/or three-dimensional symbol(s) may be located anywhere proximate to display 225 (e.g., somewhere around a perimeter of display 225), a side face of user device 100, a backside of user device 100, an inside face of user device 100 (e.g., for a clam-style user device), a top side of user device 100, a bottom side of user device 100, a left side of user device 100, a right side of user device 100, and/or other location of user device 100.

Display 225 may operate as an output component. For example, display 225 may comprise a liquid crystal display (LCD), a plasma display panel (PDP), a field emission display (FED) a thin film transistor (TFT) display, or some other type of display technology. Additionally, according to an exemplary implementation, display 225 may operate as an input component. For example, display 225 may comprise a touch-sensitive screen. In such instances, display 225 may correspond to a single-point input device (e.g., capable of sensing a single touch) or a multipoint input device (e.g., capable of sensing multiple touches that occur at the same time). Display 225 may be implemented using one of a variety of sensing technologies, such as, for example, capacitive sensing, surface acoustic wave sensing, resistive sensing, optical sensing, pressure sensing, infrared sensing, or gesture sensing. Display 225 may also provide for an auto-rotating function (e.g., automatically rotate images displayed on display 225 based on the orientation of display 225), as well as responsive to other user-touch gestures (e.g., zoom, expand, etc.). Display 225 may be capable of displaying text, pictures, and video. Display 225 may also be capable of displaying various images (e.g., icons, objects, etc.) that may be selected by a user to access various applications, enter data, navigate through user interfaces, etc.

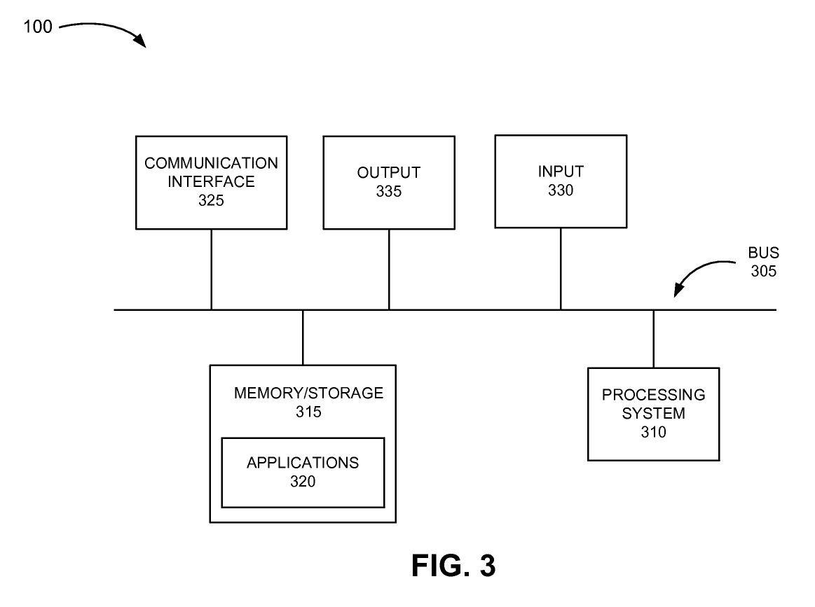

FIG. 3 is a diagram illustrating exemplary components of user device 100. As illustrated, user device 100 may comprise a bus 305, a processing system 310, a memory/storage 315 that may comprise applications 320, a communication interface 325, an input 330, and an output 335. According to other embodiments, user device 100 may comprise fewer components, additional components, different components, and/or a different arrangement of components than those illustrated in FIG. 3 and described herein.

Bus 305 may comprise a path that permits communication among the components of user device 100. For example, bus 305 may include a system bus, an address bus, a data bus, and/or a control bus. Bus 305 may also include bus drivers, bus arbiters, bus interfaces, and/or clocks.

Processing system 310 may include one or multiple processors, microprocessors, data processors, co-processors, application specific integrated circuits (ASICs), system-on-chips (SOCs), application specific instruction-set processors (ASIPs), controllers, programmable logic devices (PLDs), chipsets, field programmable gate arrays (FPGAs), and/or some other processing logic that may interpret and/or execute instructions and/or data. Processing system 310 may control the overall operation, or a portion of operation(s) performed by user device 100. Processing system 310 may perform operations based on an operating system and/or various applications (e.g., applications 320). Processing system 310 may access instructions from memory/storage 315, from other components of user device 100, and/or from a source external to user device 100 (e.g., another device or a network).

Memory/storage 315 may comprise one or multiple memories and/or one or multiple other types of tangible storage mediums. For example, memory/storage 315 may comprise one or more types of memories, such as, a random access memory (RAM), a dynamic random access memory (DRAM), a cache, a static random access memory (SRAM), a read only memory (ROM), a programmable read only memory (PROM), a ferroelectric random access memory (FRAM), an erasable programmable read only memory (EPROM), s static random access memory (SRAM), a flash memory, and/or some other form of storing hardware. Memory/storage 315 may comprise a hard disk (e.g., a magnetic disk, an optical disk, a magneto-optic disk, a solid state disk, etc.) and a corresponding drive. Memory/storage 315 may be external to and/or removable from user device 100, such as, for example, a Universal Serial Bus (USB) memory, a dongle, a hard disk, mass storage, off-line storage, or some other type of storing medium (e.g., a computer-readable medium, a compact disk (CD), a digital versatile disk (DVD), a Blu-ray™ disc (BD), or the like). The term “computer-readable medium,” as used herein, is intended to be broadly interpreted to comprise, for example, a memory, a CD, a DVD, a BD, or another type of tangible storage medium.

Memory/storage 315 may store data, applications 320, and/or instructions related to the operation of user device 100. Applications 320 may comprise software that provides various services or functions. By way of example, applications 320 may comprise a telephone application, a voice recognition application, a video application, a multi-media application, a music playing application, a texting application, an instant messaging application, etc.

Communication interface 325 may permit user device 100 to communicate with other devices, networks, and/or systems. For example, communication interface 325 may comprise one or multiple wireless and/or wired communication interfaces. Communication interface 325 may comprise a transmitter and a receiver, or a transceiver. Communication interface 325 may operate according to one or multiple protocols, communication standards, or the like.

Input 330 may permit an input into user device 100. For example, input 330 may comprise a keyboard, a keypad (e.g., keypad 220), a touch screen (e.g., display 225), a touch pad, a mouse, a port, a button, a switch, a microphone (e.g., microphone 220), voice recognition logic, an input port, a knob, and/or some other type of input component (e.g., a light sensor). Output 335 may permit user device 100 to provide an output. For example, output 335 may include a display (e.g., display 225), a speaker (e.g., speakers 215), an LED, UV LED 120, an output port, a vibratory mechanism, or some other type of output component.

User device 100 may perform operations in response to processing system 310 executing software instructions stored by memory/storage 315. For example, the software instructions may be read into memory/storage 315 from another storing medium or from another device via communication interface 325. The software instructions stored by memory/storage 315 may cause processing system 310 to perform various processes. Alternatively, user device 100 may perform processes based on the execution of hardware, hardware and firmware, and/or hardware, software, and firmware.

The foregoing description of embodiments provides illustration, but is not intended to be exhaustive or to limit implementations to the precise form disclosed. Modifications and variations of the embodiments and/or implementations are possible in light of the above teachings, or may be acquired from practice of the teachings. For example, as previously described, fluorescently-painted symbol(s) and/or fluorescent three-dimensional symbol(s) may reside(s) in other locales than those illustrated, such as, for example, housing 205, etc. Additionally, or alternatively, UV LEDs 120 may be triggered or activated to emit ultraviolet light based on various communication events (e.g., receiving a message (such as a telephone call, an email, etc.), playback of multimedia, and/or other types of light triggering event or circumstance.

The terms “comprise,” “comprises” or “comprising,” as well as synonyms thereof (e.g., include, etc.), when used in the specification is meant to specify the presence of stated features, integers, steps, or components but does not preclude the presence or addition of one or more other features, integers, steps, components, or groups thereof In other words, these terms are to be interpreted as inclusion without limitation.

Spatially relative terms, such as, for example, “top,” “bottom,” “beneath,” “upward,” “up,” “downward,” and the like, may be used for ease of description to describe one element's relationship to another element or to describe one feature's relationship to another feature, as may be illustrated in the figures and/or described. Spatially relative terms are intended to encompass different orientations of the user device in use, operation, or configuration, in addition to the use, the operation, or the configuration illustrated in the figures and/or described. For example, if the user device illustrated in a figure is turned over or oriented differently than an orientation illustrated (e.g., rotated at 90 degrees or some other rotation, etc.), the spatially relative terms used herein should be interpreted accordingly.

The terms “a,” “an,” and “the” are intended to be interpreted to include both the singular and plural forms, unless the context clearly indicates otherwise. Further, the phrase “based on” is intended to be interpreted to mean, for example, “based, at least in part, on,” unless explicitly stated otherwise. The term “and/or” is intended to be interpreted to include any and all combinations of one or more of the associated list items.

No element, act, or instruction disclosed in the specification should be construed as critical or essential to the embodiments described herein unless explicitly described as such.

What is claimed is:

1. A user device comprising:
a keypad or a keyboard comprising one or more buttons;
one or more light guides;
one or more ultraviolet light emitting elements; and
one or more fluorescently painted symbols, wherein each fluorescently painted symbol comprises a fluorescent paint that is visible to a user when exposed to visible light and is capable of emitting visible light when exposed to ultraviolet light, wherein the one or more ultraviolet light emitting elements are configured to expose ultraviolet light to the one or more fluorescently painted symbols via the one or more light guides.

2. The user device of claim 1, further comprising:
one or more light sensors to detect a level of light external to the user device, wherein the one or more ultraviolet light emitting elements are configured to emit ultraviolet light based on the level of light detected by the one or more light sensors.

3. The user device of claim 1, wherein at least one of the one or more fluorescently painted symbols is in the shape of a number, a letter, a mark, or a sign.

4. The user device of claim 1, wherein at least one of the one or more light guides comprises at least one of the one or more fluorescently painted symbols.

5. The user device of claim 1, wherein at least one of the one or more buttons comprises at least one of the one or more fluorescently painted symbols.

6. The user device of claim 1, wherein at least one of a surface of the one or more light guides comprises at least one of the one or more fluorescently painted symbols

7. The user device of claim 1, wherein at least one of the one or more ultraviolet light emitting elements are on a same plane as at least one of the one or more light guides and at a lateral location to at least one of the one or more fluorescently painted symbols.

8. The user device of claim 1, further comprising:
a display; and
a layer covering the display, wherein at least one of the one or more fluorescently painted symbols resides on a bottom surface of the layer or within the layer.

9. The user device of claim 1, wherein the one or more buttons comprise at least one of a push button or a touch button.

10. The user device of claim 1, wherein the one or more light guides comprise a material that is ultraviolet light-transparent, and the user device is a mobile communication device.

11. A user device comprising:
a keypad or a keyboard comprising one or more buttons;
one or more light guides;
one or more ultraviolet light emitting elements; and
one or more fluorescent three-dimensional symbols, wherein each fluorescent three-dimensional symbol that is capable of emitting visible light when exposed to ultraviolet light, and wherein the one or more ultraviolet light emitting elements are configured to expose ultraviolet light to the one or more fluorescent three-dimensional symbols via the one or more light guides.

12. The user device of claim 11, further comprising:
one or more light sensors to detect a level of light external to the user device, wherein the one or more ultraviolet light emitting elements are configured to emit ultraviolet light based on the level of light detected by the one or more light sensors.

13. The user device of claim 12, wherein the one or more fluorescent three-dimensional symbol comprises an ultraviolet light-transparent material further comprising a three-dimensional section having a shape of a three-dimensional symbol, in which the three-dimensional section comprises the ultraviolet light-transparent material and fluorescent pigments or particles.

14. The user device of claim 11, wherein at least one of the one or more fluorescent three-dimensional symbols is in the shape of a number, a letter, a mark, or a sign.

15. The user device of claim 11, wherein at least one of the one or more light guides comprises at least one of the one or more fluorescent three-dimensional symbols.

16. The user device of claim 11, wherein at least one of the one or more buttons comprises at least one of the one or more fluorescent three-dimensional symbols.

17. The user device of claim 16, wherein the one or more buttons are touch buttons.

18. The user device of claim 11, wherein the one or more light guides comprise a material that is ultraviolet light-transparent.

19. The user device of claim 11, further comprising:
a display; and
a layer covering the display, wherein at least one of the one or more fluorescent three-dimensional symbols resides on a bottom surface of the layer or within the layer.

20. The user device of claim 11, wherein the user device is a mobile communication device.
